(19) United States
(12) Patent Application Publication
(10) Pub. No.: US 2025/0265254 A1
(43) Pub. Date: Aug. 21, 2025

(54) ARTIFICIAL INTELLIGENT (AI) AGENT CONTROL AND PROGRESS INDICATOR

(71) Applicant: Adobe Inc., San Jose, CA (US)

(72) Inventors: Michele Saad, Austin, TX (US); Irgelkha Mejia, River Edge, NJ (US); Ajay Jain, San Jose, CA (US)

(73) Assignee: Adobe Inc., San Jose, CA (US)

(21) Appl. No.: 18/581,762

(22) Filed: Feb. 20, 2024

(51) Int. Cl. G06F 16/2457; G06F 16/248; G06F 16/28

(52) U.S. Cl. CPC G06F 16/24578; G06F 16/248; G06F 16/285

(57) ABSTRACT

Artificial intelligence (AI) agent control and progress indicator techniques are described. A search-query type of a search query, for instance, is detected using a machine-learning model. Responsive to detecting the search-query type is a first type, the search query is communicated for processing by an algorithmic search engine to generate a search result. Responsive to the detecting that the search-query type is a second type, the search query is communicated for processing using an artificial intelligence (AI) search assistant implemented using a large language model (LLM) to generate the search result.

### BACKGROUND

Digital services are commonly available that provide access to thousands and even millions of items of interest. Examples of items provided by digital services include digital content, itself (e.g., digital videos, digital music), digital content representative of other items (e.g., products for sale), and so forth. Consequently, search functionality and accuracy of the search functionality is a primary driver in efficiency in locating a particular item of interest.

However, conventional techniques that have been developed and are continually developed as observed in real-world scenarios consume increasing amounts of computational resources. This problem is further challenged when confronted by a multitude of search requests that are received to locate the thousands and even millions of items of interest, thereby resulting in increased power consumption and decreased user satisfaction.

### SUMMARY

Artificial intelligence (AI) agent control and progress indicator techniques are described. In one or more examples, a search-query type of a search query is detected using a machine-learning model, e.g., a classifier. Responsive to detecting the search-query type is a first type (e.g., in which an intent is directly expressed in the search query), the search query is communicated for processing by an algorithmic search engine to generate a search result. Responsive to detecting that the search-query type is a second type (e.g., in which an intent is to be inferred from the search query), the search query is communicated for processing using an artificial intelligence (AI) search assistant implemented using a large language model (LLM) to generate the search result.

In one or more additional examples, a search query is received and used to project a target usable to achieve a goal of the search query. One or more search results are generated based on the search query and a progress indicator is output for display in a user interface. The progress indicator is updatable to indicate a relative amount of progress towards reaching the target. The amount is based, in one or more examples, on selection of one or more items from the one or more search results.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ artificial intelligence (AI) agent control and progress indicator techniques described herein.

FIG. 2 depicts a system in an example implementation showing operation of a query detector module as part of a digital search service in greater detail.

FIG. 3 is a flow diagram depicting a step-by-step procedure in an example implementation of operations performable by a processing device for accomplishing a result of artificial intelligence (AI) agent control of search functionality based on search type detection.

FIG. 4 depicts a system in an example implementation showing training and operation of an AI search assistant module of FIG. 2 in greater detail.

FIG. 5 depicts a system in an example implementation showing operation of the search module of FIG. 4 in greater detail as employing category and item retrieval as part of performing a search.

FIG. 6 is a flow diagram depicting a step-by-step procedure in an example implementation of operations performable by a processing device for accomplishing a result of generating a search result using a hierarchical technique.

FIG. 7 depicts an example implementation of a user interface configured to support search query input and prompt output based on the search query.

FIG. 8 depicts an example implementation of a user interface configured to continue support of search query input and prompt output based on the search query as described in relation to FIG. 7.

FIG. 9 depicts an example implementation of a user interface configured to continue support of search query input and prompt output based on the search query as described in relation to FIG. 8.

FIG. 10 depicts an example implementation of a user interface configured to continue support of search query input and prompt output based on the search query as described in relation to FIG. 9.

FIG. 11 is a flow diagram depicting an algorithm as a step-by-step procedure in an example implementation of operations performable for accomplishing a result of projection of a target and use of the projection for configuration of a progress indicator.

FIG. 12 illustrates an example system including various components of an example device that can be implemented as any type of computing device as described and/or utilize with reference to the previous figures to implement embodiments of the techniques described herein.

### DETAILED DESCRIPTION

### Overview

Search is utilized as an underlying functionality in support of a variety of different computing device operations, examples of which include operations that are executable locally at a computing device, remotely as part of one or more digital services, and so forth. As the amount of functionality that is made available via search continues to increase, however, so too does the amount of computing resources that are consumed by this search functionality.

Additionally, search functionality complexity also continues to increase, both with respect to complexity of search queries that are supported by the search functionality as well as complexity of search results generated in response to the search queries. These technical challenges have caused operational inefficiencies in real-world scenarios, which are further increased in situations involving multitudes of items being searched, multitudes of entities accessing the search functionality (e.g., as part of a digital service), and so forth.

Accordingly, artificial intelligence (AI) agent control and progress indicator techniques are described that address these and other technical challenges as part of computing device operation and user interaction involving search functionality. These techniques are usable to optimize computational resource consumption by employing resources corresponding with different types of search queries. Large language models (LLMs), for instance, have been developed as part of implementing artificial intelligence to expand search functionality. However, operation of LLMs is computationally expensive, both to train the machine-learning models as well as to use to machine-learning models. This is especially true when implemented as part of a digital service that supports hundreds of millions of search requests in a single day.

Therefore, in this scenario, an artificial intelligence (AI) agent control techniques are supported in which a search-query type is detected for a search query by a query detector module. The query detector module, in one or more examples, is implemented as a classifier using machine learning to classify search queries based on type. The search query type is then usable by the query detector module to control which search functionality is to be employed to generate a search result in a manner that optimizes computational resource consumption and search accuracy.

A search query, for instance, is received that specifies “dog collar.” Thus, the search query in this example directly expresses (e.g., explicitly) an intent of the search query, i.e., to locate a dog collar. This search query in this instance is therefore communicated by the query detector module to an algorithmic search engine module that is configured to perform a search based on this readily identified intent, e.g., through a keyword search. The algorithmic search engine module, in real world operation, has reduced computational resource consumption with similar accuracy in this type of instance when compared with artificial intelligence based approaches.

In another instance, however, the query detector module is configured to detect that a search query is configured such that an intent is not directly expressed, but rather is to be inferred from the search query. A search query of “what clothes should a teenager pack for a trip to Seattle this weekend to play soccer,” for example, does not directly express then intent, but rather the intent is implicit in the search query and thus is to be inferred, e.g., through natural language processing. Therefore, the query detector module in this example communicates the search query to an artificial intelligence (AI) search assistant module. The AI search assistant module is configured to employ machine learning (e.g., an LLM) to generate the search result in part by inferring intent from the search result.

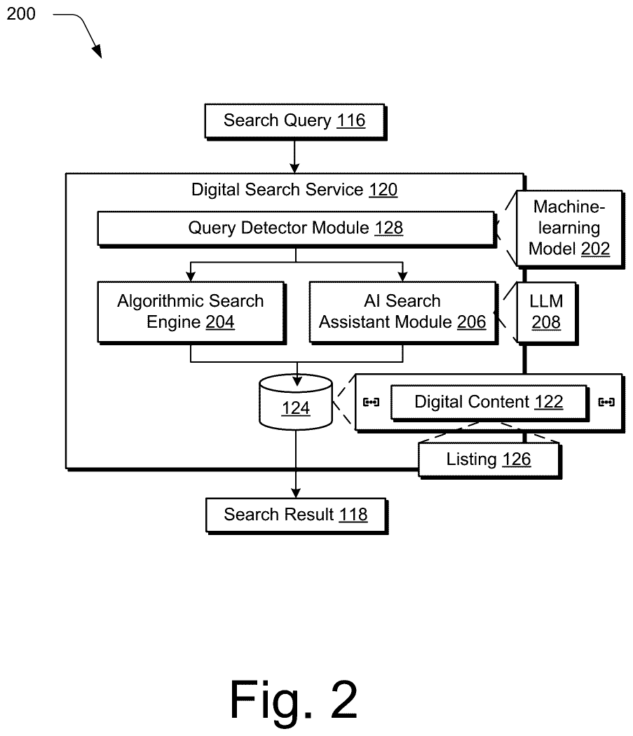

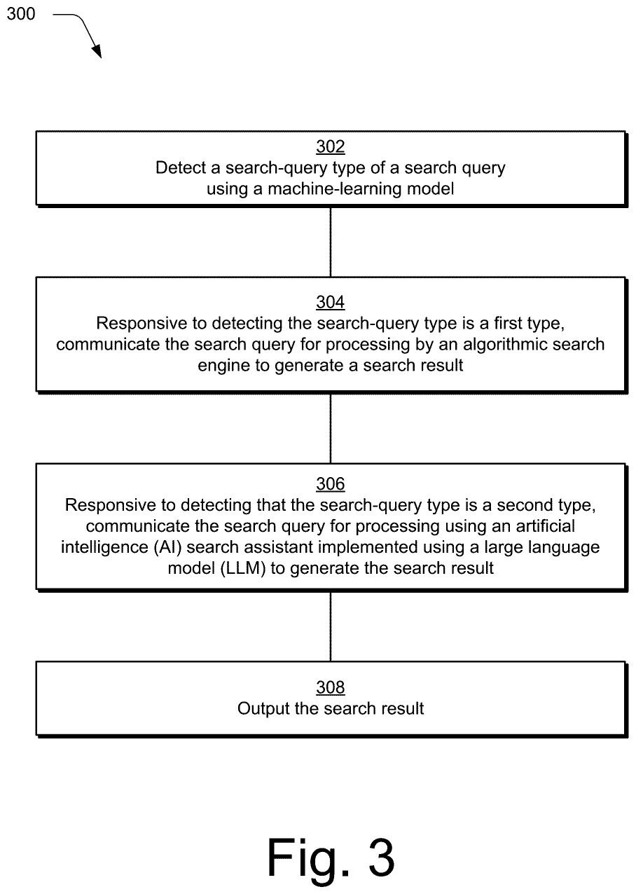

Continuing with the above example, the intent is inferred by the AI search assistant module to locate clothes suitable for the teenager to play outside based on weather conditions predicted for a particular location at a particular time. In this way, the query detector module is configured to support applicable use of resources and corresponding functionalities as part of controlling search functionality, which is not possible in conventional techniques. Further discussion of these and other examples of query-based control of search functionality may be found in relation to FIGS. 2-3.

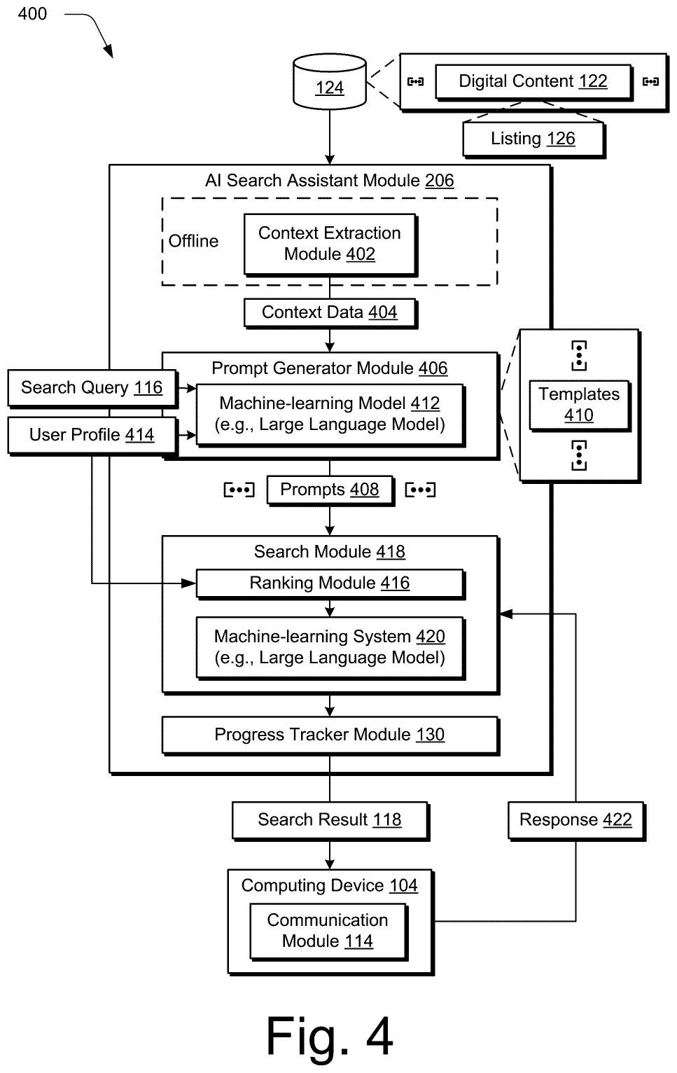

In another scenario, an artificial intelligence (AI) search assistant module is configured to generate prompts that are usable to further refine intent from search queries as part of generating a search result. The AI search assistant module, for instance, is configured to generate prompts to identify categories from digital content based on a search query. The AI search assistant module is then usable to further generate prompts based on the categories to locate items within the categories based on responses to the prompts, a user profile, and so forth. The items are then ranked as output by the AI search assistant module as a search result. In this way, the AI search assistant module supports functionality to increase search result accuracy, further discussion of which may be found in relation to FIGS. 4-10.

As previously described, search functionality also continues to expand in complexity, both in an ability in how search queries are expressed and also in ways in which search results are configured to meet those requests. This complexity may therefore result in user confusion in conventional techniques regarding how to progress towards a desired result that is a basis of the search.

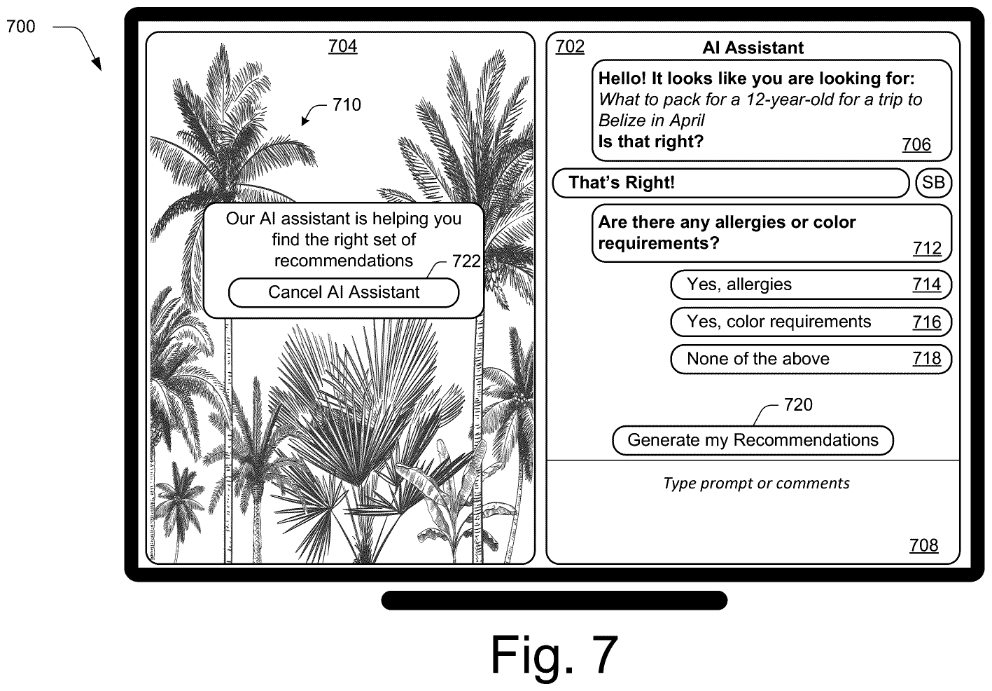

Accordingly, techniques are also described in which a progress indicator is utilized to provide user insight into advancement towards a desired result associated with a search query. The AI search assistant module, for instance, receives a search query and projects a target to achieve a goal of the search query. Continuing with the above example, the AI search assistant module determines categories that are involved towards a target, e.g., “raingear,” “sweatshirts,” and “portable shelter” for the soccer example above. As items are selected for each of the categories, the progress indicator is updated to indicate a relative amount of progress towards reaching the target, e.g., items for use in the soccer example. Functionality is also supported to select which categories are used towards defining this target, e.g., through slider controls in a user interface. In this way, the progress indicator indicates respective steps along a journey towards fulfillment of a desired result associated with a search query, which is not possible in conventional techniques. Further discussion of these and other examples may be found in relation to FIGS. 7-11.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Digital Search Environment

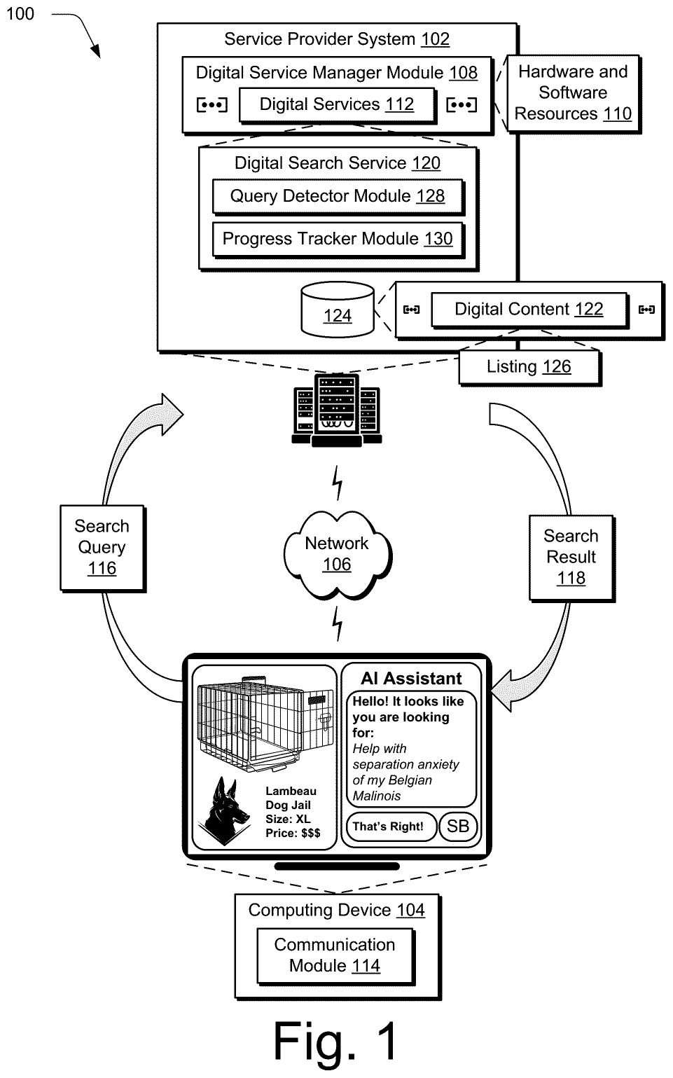

FIG. 1 is an illustration of a digital medium search environment 100 in an example implementation that is operable to employ artificial intelligence (AI) agent control and progress indicator techniques described herein. The illustrated environment 100 includes a service provider system 102 and a computing device 104 that are communicatively coupled, one to another, via a network 106. Computing devices are configurable in a variety of ways.

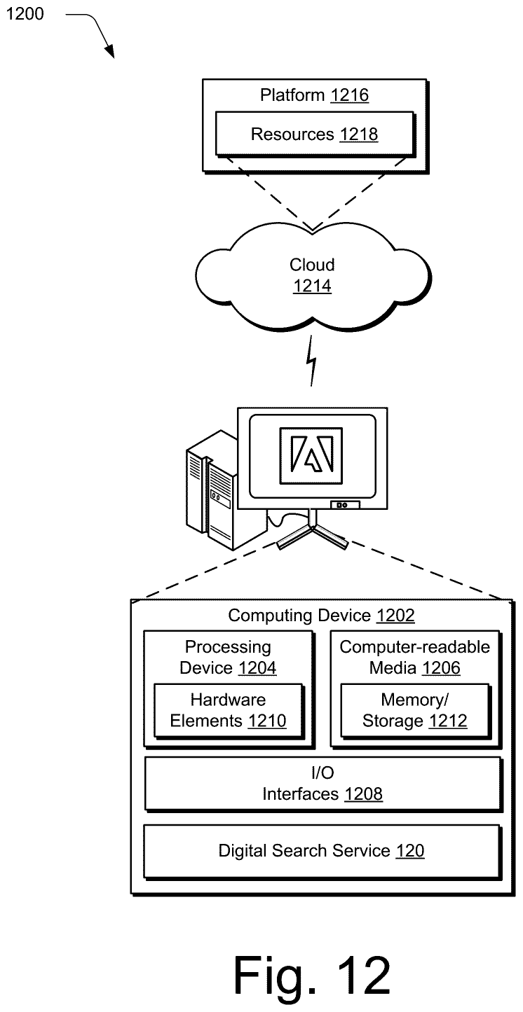

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 12.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104. Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on.

Accordingly, in the illustrated example, a communication module 114 (e.g., browser, network-enabled application, and so on) is utilized by the computing device 104 to access the one or more digital services 112 via the network 106. The communication module 114, for instance, generates a search query 116 and receives a search result 118 from a digital search service 120. The digital search service 120 is configured to locate items of digital content 122 in this instance, which are illustrated as stored in a storage device 124. Examples of digital content 122 include digital images, digital media, digital video, digital documents, social media posts, recommendations, advertisements, and so forth that may be streamed, downloaded, or otherwise communicated via the network 106. Digital content 122 is also configurable to represent other items that are to be made available via the digital services 112, such as a listing 126 for products or services that are to be made available for purchase, download, subscription, and so forth.

The digital search service 120 is configured to implement a variety of functionalities usable to improve computational resource consumption efficiency as part of search implementation as well as insight into progress towards achieving a target of a search. In a first example, a query detector module 128 is implemented as a classifier using machine learning (e.g., a binary classifier) to classify the search query 116 based on search query type. The search query type, once detected, is then usable by the query detector module 128 to control which search functionality (e.g., search engine) is to be employed to generate a search result in a manner that optimizes computational resource consumption and search accuracy, further discussion of which is described in relation to FIGS. 2-3.

In a second example, a progress tracker module 130 is configured to indicate an amount of progress achieved towards achieving a goal based on the search query 116. As previously described, search functionality continues to expand in complexity, both in an ability in how search queries are expressed and also in the ways in which search results are configured to meet those requests. As a result, this complexity in conventional techniques causes user confusion regarding how to progress and how much progress has been achieved towards a desired result that is a basis of the search.

Accordingly, the progress tracker module 130 is configurable to output a progress tracker for display in a user interface to provide user insight into advancement towards a desired result associated with a search query. In this way, the progress indicator indicates respective steps along a journey towards fulfillment of a desired result associated with a search query, which is not possible in conventional techniques. Further discussion of this and other examples may be found in relation to FIGS. 7-11.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Search Control and Progress Indication

The following discussion describes artificial intelligence (AI) agent control and progress indicator techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

In the following examples, search techniques are described that are configurable to infer an intent from a search query, and based on that intent, locate multiple items across multiple categories to achieve a goal of the intent. The search techniques therefore facilitate a path to provide context for different scenarios and aligns items based on the scenarios as part of a search result.

The search techniques also support a progress indicator as a feedback mechanism in relation to a target derived from a search query. The search techniques also support an ability to “opt-out” of individual categories, which is usable to update both the target and progress toward the target indicated by the progress indictor. The search techniques are also configurable to employ different search functionalities based on search-query types identified from the search queries. The search-query types, for instance, are usable to distinguish between search queries that explicitly describe intent and search queries that are configured for an implicit determination of intent. The search-query types are then routed based on to corresponding search functionalities, thereby optimizing search performance. Accordingly, the described techniques support a holistic search experience that is configured to ascertain items that are suited for a scenario determined from a search query, reduce time spent by computing devices and users to perform the search, and achieve search results that are based on explicit and/or implicit intent.

The digital search service, for instance, is configurable to infer intent based on parameters included as part of a search query. Examples of the parameters include place/destination, event type, time of year, travel type, planned activities, level of expertise, and so forth. These parameters may then be mapped, using machine learning, to a corpus of digital content. A search result, for instance, includes items categorized from the digital content, which may be weighted based on factors such as impact, importance, cause, and so forth. A hierarchical search retrieval technique is usable to surface relevant categories and a listed of weighted items within the categories. Additionally, computational resource consumption is also addressed (e.g., and potential latency issues) through search-type detection as described above.

FIG. 2 depicts a system 200 in an example implementation showing operation of a query detector module as part of a digital search service in greater detail. FIG. 3 is a flow diagram depicting a step-by-step procedure 300 in an example implementation of operations performable by a processing device for accomplishing a result of artificial intelligence (AI) agent control of search functionality based on search type detection. In the following discussion, operation of the system 200 of FIG. 2 is described in parallel with the procedure 300 of FIG. 3.

To begin in this example, the digital search service 120 receives a search query 116, although local implementation by the computing device 104 is also contemplated. The incoming search query 116 is passed as an input to a query detector module 128. The query detector module 128 is configured to detect a search-query type using a machine-learning model 202 (block 302). The machine-learning model 202 is configurable as a classifier that is trained and retrained to classify the search query 116 into a respective category, referred to as a first category or a second category in this example, although additional numbers of categories are also contemplated. The machine-learning model 202, for instance, is configurable as a trained supervised machine-learning model that acts as a binary classifier, such as through implementation as a random-forest model or a boosted classifier model, employ logistic regression, or other configurations as further described below.

In this example, the first type is “explicit” such that the search query 116 directly describes a goal of the search query 116. A search query of “red dog collar.” for instance, explicitly describes the goal of the search query 116 such that an intent of the search query is fully developed, formulated, and is unambiguous in expression.

The second type in this example is “implicit” such that the search query 116 does not directly define the goal, but rather the goal is inferred through from search query 116. A search query of “what to pack for a 12-year-old for a trip to Belize in April,” for instance, does not explicitly describe the goal of the search. Rather, the goal is to be determined through semantic analysis of the search query 116, e.g., through natural language processing.

Accordingly, the query detector module 128 is configured in this example to route the search query 116 to search functionality that is suitable for processing of the search-query type detected for the search query 116. Examples of search functionality are illustrated in FIG. 2 as an algorithmic search engine 204 and an artificial intelligence (AI) search assistant module, depicted as AI search assistant module 206.

Responsive to detecting the search-query type is a first type, the search query is communicated for processing by an algorithmic search engine 204 to generate a search result (block 304) in the illustrated example. The algorithmic search engine 204 is configurable to employ predefined algorithms and rule-based methods to index, categorize, and retrieve items of digital content 122. This is performable in this example independent of machine learning. Therefore, instead of learning from data or user behavior in this example, the algorithmic search engine 204 uses fixed rules and patterns to analyze and rank the digital content 122. This approach may leverage a variety of techniques to do so. Example of these techniques include keyword frequency analysis, Boolean search logic, link analysis, HTML tags and metadata assessment, and so forth.

Accordingly, the algorithmic search engine 204 in this example is configurable to rely on structural and lexical properties of the digital content 122, without dynamically adapting or evolving their understanding based on new data inputs, as is characteristic of machine-learning-based systems. In this way, the algorithmic search engine 204 supports a deterministic and straightforward approach to search, based on explicit programming and direct data processing techniques.

The algorithmic search engine 204, for instance, is usable to implement a keyword search that involves use of specific words or phrases that are then located in the digital content 122 (e.g., using an index) to find exact matches or close variations. Examples of the algorithmic search engine functionality include use of Boolean search logic, keyword frequency algorithmic analysis, keyword density algorithmic analysis, hypertext markup language (HTML) tag algorithmic analysis, link algorithmic analysis, lexical algorithmic analysis, static ranking factor algorithmic analysis, pattern matching algorithmic analysis, regular expression algorithmic analysis, semantic algorithmic analysis, or keyword matching algorithmic analysis. In real world scenarios, the algorithmic search engine 204 has exhibited appropriate amounts of accuracy with decreased usage of computational resources, as opposed to the use of computational resources observed in real-world scenarios for machine-learning-based techniques.

On the other hand, responsive to detecting the search-query type is a second type, the search query 116 is communicated by the query detector module 128 for processing by an artificial intelligence (AI) search assistant. The AI search assistant is implemented by an AI search assistant module 206 using a large language model (i.e., LLM 208) to generate the search result (block 306).

The LLM 208 is configurable to infer intent from the search query 116 through a process of deep learning and natural language processing (NLP). The LLM 208 is implemented, in one or more examples, using a transformer architecture that is configured to address a sequential nature of the search result 118, and more particularly text included in the search query 116. During training, the LLM 208 is configured to predict parts of the text based on a context by adjusting weights of a neural network to achieve a contemplated output.

The LLM 208 in this example, once trained, is compatible to process natural language queries by parsing a structure, identifying key terms, and inferring context and intent behind the search query 116 based on the context. Through analysis in which the text of the search query 116 is used, the LLM 208 is configurable to detect different meanings and nuances. As a result, the LLM 208 is configurable to differentiate between different uses of a same item of text based on context, e.g., “Adobe” as a clay building material versus “Adobe” as a computer software company.

The LLM 208 is also configurable to generate prompts to infer a likely intent using follow-up questions in a sequence as further described in relation to FIGS. 4-10. The search result is then output (block 308) for display in a user interface. In this way, the query detector module 128 is usable to optimize utilization of computational resources of computing devices that implement the search techniques while preserving search accuracy, which is not possible in conventional techniques.

FIG. 4 depicts a system 400 in an example implementation showing training and operation of the AI search assistant module 206 of FIG. 2 in greater detail. To begin in this example, a context extraction module 402 is implemented to extract context data 404 from the digital content 122. The context extraction module 402, for instance, is configurable to implement an offline process that preprocesses a catalog of the digital content 122 and generates a summarization of a context of the digital content 122 as context data 404. To do so, the context extraction module 402 is configurable to take as an input the digital content 122 (e.g., catalog data) and embed the digital content 122 in a vector space. The embedding then serves as a basis of what is represented by the digital content 122. Accordingly, the context data 404 is configurable in a variety of ways, such as a natural language summary describing “what is meant” by the digital content 122.

The context data 404 is then passed as an input to a prompt generator module 406. The prompt generator module 406 is configured to generate a prompt 408 as a way to clarify underlying intent of a search query 116. The prompt generator module 406, for instance, generates the prompt 408 including natural-language text through use of one or more templates 410.

A machine-learning model 412 (e.g., configurable as a large language model), for instance, is leveraged to generate a set of follow-up questions to gain further clarification of an objective of the search query 116. In one or more examples, the machine-learning model 412 does so by first generating one or more general prompts that are not yet tuned or personalized for user preferences, e.g., do not yet use a user profile 414 detailing those preferences. According, in this example the initial set of prompts 408 output by the prompt generator module 406 are not yet tuned for further input for the user and are not personalized to the user profile 414.

To do so, the prompt generator module 406 is configurable to generate a large list of candidate prompts that account of user profiles of users that access the digital services 112, and more particularly the digital search service 120. This list is then cached in one or more examples for performance efficiency and is usable to refine results to then fit the user profile 414 through subsequent prompts output by the prompt generator module 406, e.g., after the initial set of general prompts.

The candidate prompts, for example, are generated as a superset of what is expected to be of interest to the user as part of the search. Pre-generation of the candidate prompts (e.g., offline) is usable to increase responsiveness of the AI search assistant module 206 as the prompts are reranked by a ranking module 416 of a search module 418 as further described below.

A search module 418 takes as an input the prompts 408 (e.g., a list of candidate questions generated by the machine-learning model 412) and a summary of the user profile 414 in the form of an embedding, a textual list of keywords, and so on. If the user profile 414 is configured as a textual list of keywords, for instance, the keywords are embedded in a contextual vector space and combined into a single embedding. A machine-learning system 420 is employed to perform a search based on a response 422 received to the prompts 408, the search query 116, the user profile 414, and so on. The response 422 is then usable by the ranking module 416 for reranking of the prompts 408, e.g., as a function of computing distance between the prompts 408, the user profile 414, and the response 422 in a same contextual embedding space used to generate the context data 404.

The distances between the user profile 414 and the prompts 408, for instance, are usable to rank the prompts 408 based on appropriateness. Once a threshold amount of information is obtained in this example, the machine-learning system 420 is then employed to generate the search result 118. In this way, the response 422 provides feedback to the prompt 408, which may then be further refined and used as a basis to perform the search, further discussion of which is included in the following descriptions and shown in corresponding figures.

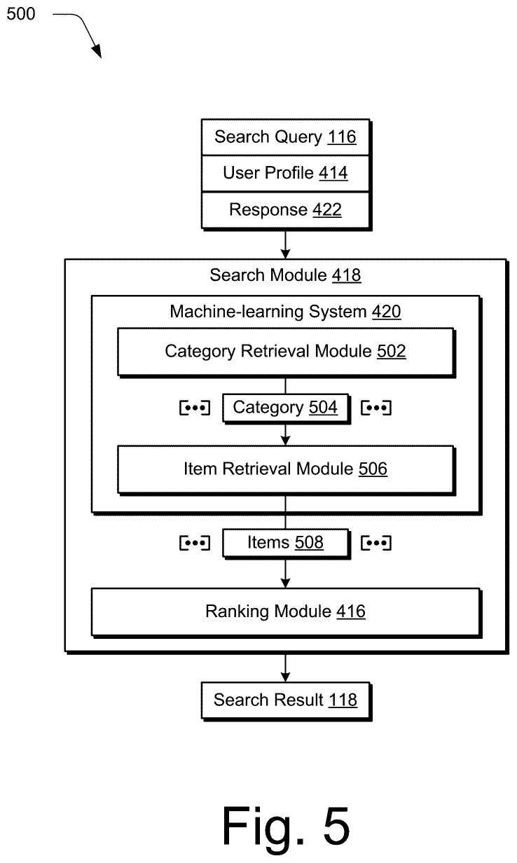

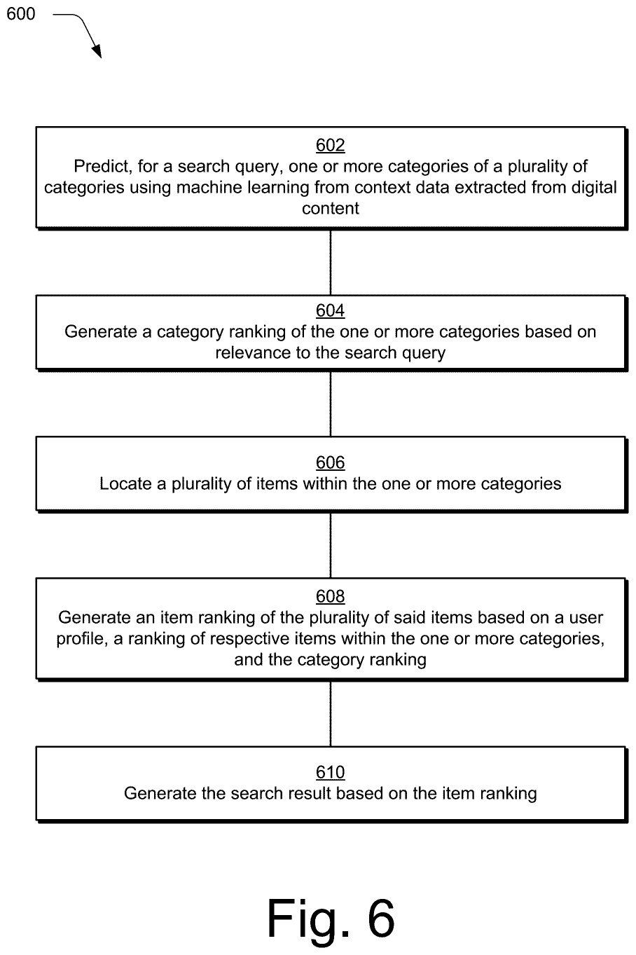

FIG. 5 depicts a system 500 in an example implementation showing operation of the search module 418 of FIG. 4 in greater detail as employing category and item retrieval as part of performing a search. FIG. 6 is a flow diagram depicting a step-by-step procedure 600 in an example implementation of operations performable by a processing device for accomplishing a result of generating a search result using a hierarchical technique. In the following discussion, operation of the system 500 of FIG. 5 is described in parallel with the procedure 600 of FIG. 6.

The search module 418 is configurable to employ a variety of inputs as part of performing a search as described above, illustrated examples of which include a search query 116, a user profile 414, a response 422 to a prompt 408, and so forth. The machine-learning system 420, through use of one or more machine-learning models, algorithmic techniques, and so forth is then employed to implement a hierarchical search strategy in which a control retrieval module 502 is employed to identify categories 504 from the digital content 122. An item retrieval module 506 is then employed to identify items 508 from within the categories 504, which are then ranked by the ranking module 416 to form the search result 118.

Accordingly, one or more categories of a plurality of categories are first predicted using machine learning from context data 404 extracted from the digital content 122 (block 602). A category ranking is then generated for the one or more categories based on relevancy to the search query 116 (block 604), e.g., based on distance within an embedding space. After which, a plurality of items is located within the one or more categories (block 606) and used as a basis to generate an item ranking based on the user profile, a ranking of respective items within the one or more categories, and the category ranking (block 608). The search result 118 is then generated based on the ranking (block 610).

In this way, the search module 418 predicts the categories 504 that are likely to satisfy the search query 116. The categories 504 are then ranking by importance and relevance to the search query 116 and displayed accordingly. Within each category, a separate retrieval algorithm is invoked by the item retrieval module 506 to match the items 508 to the search query 116. Within the retrieved list of items within each of the categories 504, the items are re-ranked based on the user profile 414 to support personalization, customization, and likely accuracy of the search result 118.

FIG. 7 depicts an example implementation of a user interface 700 configured to support search query input and prompt output based on the search query. The user interface 700 includes a sidebar 702 configured to implement an artificial intelligence (AI) assistant and a portion 704 that is configured to output the search result 118. A search query 706, input via a text entry portion 708 of the user interface 700, is displayed in the sidebar 702. The search query 706 in this example states “What to pack for a 12-year-old for a trip to Belize in April.” In response, a digital image 710 is output as part of the portion 704, which in the illustrated example is based at least generally on the search query 706. The digital image 710, for instance, includes a picture of palm trees located based on inclusion of a keyword “Belize” in the search query 706.

The sidebar 702 includes a prompt 712 based off the search query 706, including selectable first, second, and third options 714, 716, 718 as responses to the prompt 712. The sidebar 702, for instance, outputs the prompt 712 as “Are there any allergies or color requirements?” The first option 714 is selectable to indicate “Yes, allergies,” the second option 716 is selectable to indicate “Yes, color requirements,” and the third option 718 is selectable to indicate “None of the above.” An option 720 is also included in the sidebar 702 to “Generate my recommendations” as the search result 118, which in this example is items for sale. The sidebar 702 further includes a control 722 that is selectable via the user interface 700 to cancel output of the sidebar 702 and corresponding AI assistant.

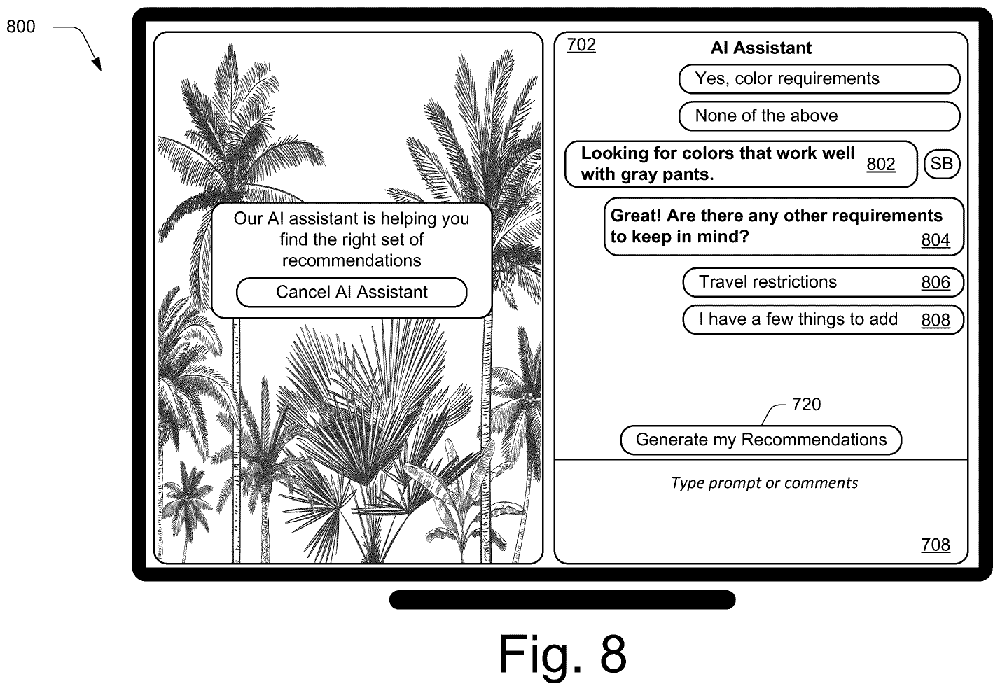

FIG. 8 depicts an example implementation of a user interface 800 configured to continue support of search query input and prompt output based on the search query as described in relation to FIG. 7. In this example, a response 802 is received via the text entry portion 708 as selection of the second option 716 of “Yes, color requirements” of text of “Looking for colors that work well with gray pants.” An additional prompt 804 is then output of “Great! Are there any other requirements to keep in mind” along with first and second options 806, 808 of preconfigured responses of “Travel restrictions” and “I have a few things to add,” respectively.

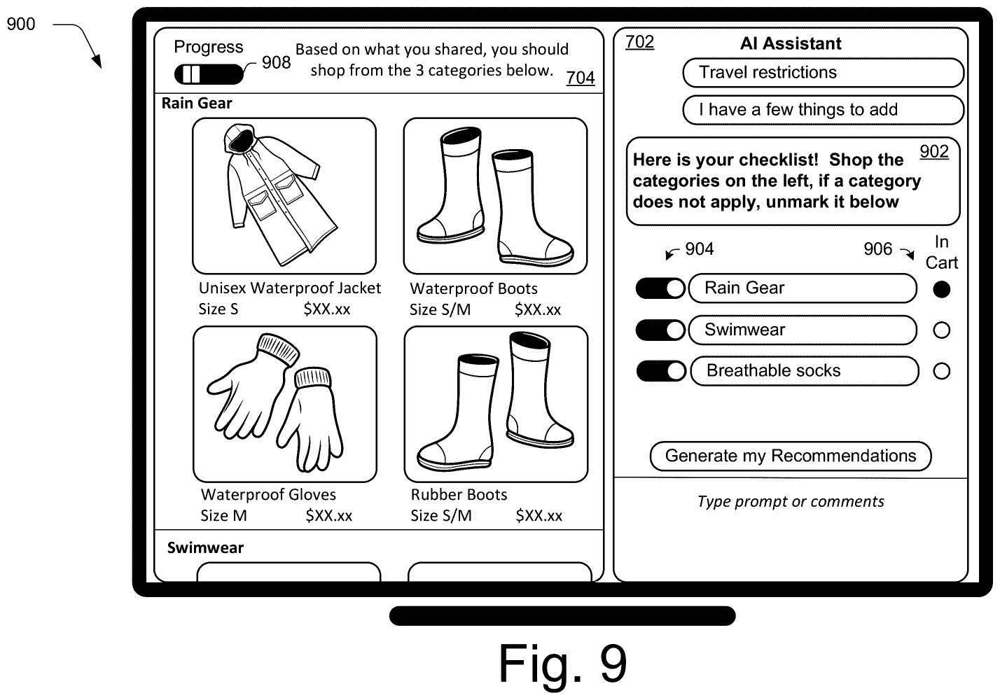

FIG. 9 depicts an example implementation of a user interface 900 configured to continue support of search query input and prompt output based on the search query as described in relation to FIG. 8. In this example, a threshold amount of information has been received and detected by the search module 418 as indicating a sufficient inference of intent has been gained in order to generate the search result 118. In response, automatically and without user intervention in this example, representations of the items are displayed in the portion 704 following a hierarchical arrangement based on categories and items within the categories.

The sidebar 702 of the AI assistant also includes an indication 902 of “Here is your checklist! Shop the categories on the left, if a category does not apply, unmark it below.” The sidebar 702 also includes options 904 that are selectable to control which categories are surfaced in the sidebar 702. Examples of the categories include “Rain Gear,” “Swimwear,” and “Breathable socks,” with the options 904 configured as slider controls in the illustrated example. The representations of the items are user selectable to initiate a purchase of the represented item.

Indications 906 are also included that designate which categories include items that have been selected for inclusion in the cart, i.e., for purchase. In the illustrated example, items related to “rain gear” are selected and indicated as “in the cart.”

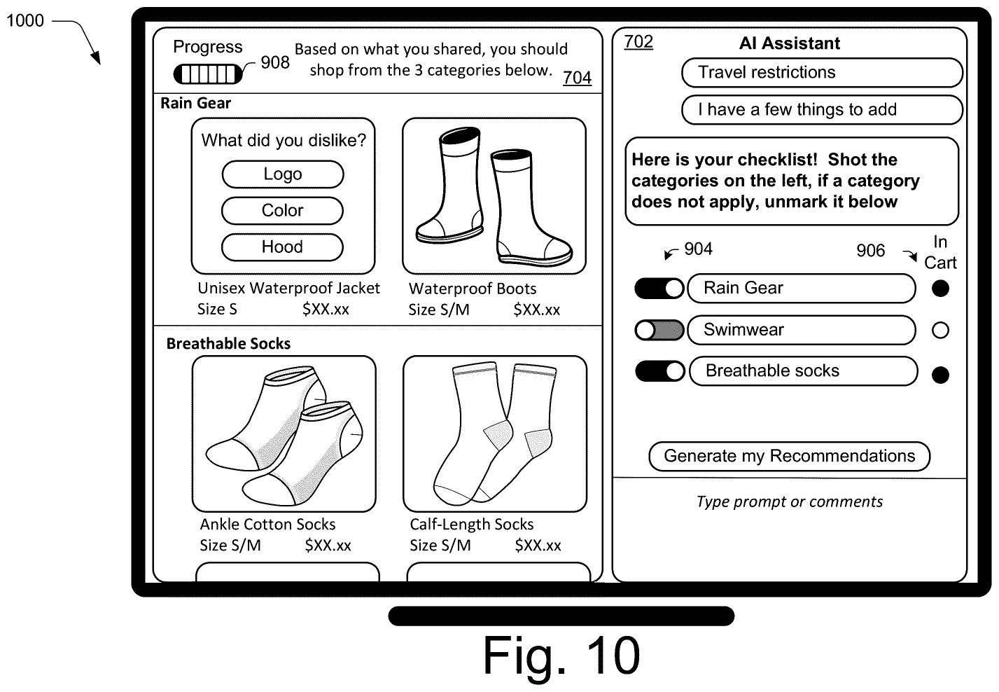

FIG. 10 depicts an example implementation of a user interface 1000 configured to continue support of search query input and prompt output based on the search query as described in relation to FIG. 9. In this example, an option 904 for “swimwear” is deselected, thereby cause items in the swimwear category to be removed from the portion 704 of the user interface 1000.

Indications 906 are also updated that designate which categories include items that have been selected for inclusion in the cart, i.e., for purchase. In this example, both categories of “Rain Gear” and “Breathable Socks” have items that are selected for purchase. As a result, the user is made aware of progress towards completing the individual categories identifier as part of the search. A variety of other techniques are also contemplated, an example of which is described as follows and shown in a corresponding figure.

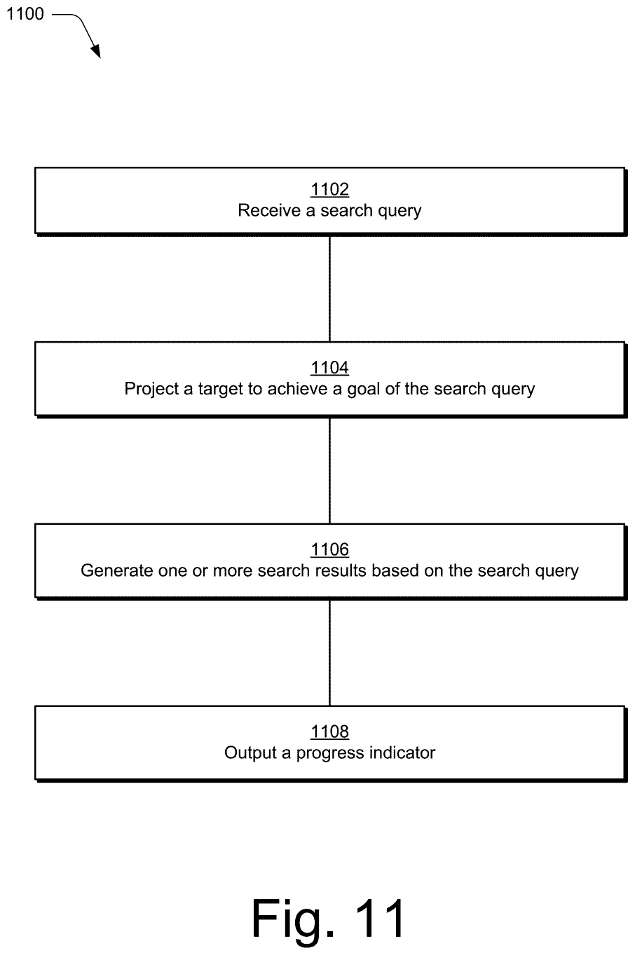

FIG. 11 is a flow diagram depicting an algorithm 1100 as a step-by-step procedure in an example implementation of operations performable for accomplishing a result of projection of a target and use of the projection for configuration of a progress indicator. In this example, a search query is received (block 1102) and a target is projected to achieve a goal of the search query (block 1104), e.g., which categories will achieve a result inferred and/or explicitly defined in the search query. One or more search results are generated based on the search query (block 1106) and a progress indicator (block 1108) is output indicating a relative amount of progress towards reaching the target, e.g., a number of items that are acquired towards achieving the target. The amount is based on selection of one or more items from the one or more search results, e.g., items in the respective categories.

As previously described, search functionality continues to expand in complexity, both in an ability in how search queries are expressed and also in ways in which search results are configured to meet those requests. This complexity may therefore result in user confusion in conventional techniques regarding how to progress towards a desired result that is a basis of the search.

Accordingly, techniques are also described in which a progress indicator 906 as depicted in FIGS. 9 and 10 is utilized by a progress tracker module 130 to provide user insight into advancement towards a desired result associated with a search query. The progress tracker module 130, for instance, receives a search query and projects a target to achieve a goal of the search query. Continuing with illustrated examples of FIGS. 7-10, for instance, the progress tracker module 130 determines categories that are involved towards a target, e.g., “Rain Gear,” “Swimwear,” and “Breathable socks” for the Belize example.

As items are selected for each of the categories, the progress indicator 908 is updated by the progress tracker module 130 to indicate a relative amount of progress towards reaching the target. As shown in FIG. 9, for instance, the progress indicator 906 indicates selection of items in one of three categories, which is indicated in the progress indicator 906 as two bars out of a possible six bars. In FIG. 10, however, one of the categories has been deselected, and items are selected for acquisition for each of the selected categories. Accordingly, the progress indicator 906 of FIG. 10 is shown as “complete” or “full” by having six bars. In this way, the progress indicator 906 indicates respective steps along a journey towards fulfillment of a desired result associated with a search query, which is not possible in conventional techniques.

The previous examples describe multiple instances of machine-learning models. Machine-learning models refers to a computer representation that is tunable (e.g., through training and retraining) based on inputs without being actively programmed by a user to approximate unknown functions, automatically and without user intervention. In particular, the term machine-learning model includes a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A machine-learning model, for instance, is configurable using a plurality of layers having, respectively, a plurality of nodes. The plurality of layers are configurable to include an input layer, an output layer, and one or more hidden layers. Calculations are performed by the nodes within the layers via hidden states through a system of weighted connections that are “learned” during training of the machine-learning model to implement a variety of tasks.

In order to train the machine-learning model, training data is received that provides examples of “what is to be learned” by the machine-learning model, i.e., as a basis to learn patterns from the data. The machine-learning system, for instance, collects and preprocesses the training data that includes input features and corresponding target labels, i.e., of what is exhibited by the input features. The machine-learning system then initializes parameters of the machine-learning model, which are used by the machine-learning model as internal variables to represent and process information during training and represent interferences gained through training. In an implementation, the training data is separated into batches to improve processing and optimization efficiency of the parameters of the machine-learning model during training.

The training data is then received as an input by the machine-learning model and used as a basis for generating predictions based on a current state of parameters of layers and corresponding nodes of the model, a result of which is output as output data, e.g., a search result, prompt, and so forth.

Training of the machine-learning model includes calculating a loss function to quantify a loss associated with operations performed by nodes of the machine-learning model. The calculating of the loss function, for instance, includes comparing a difference between predictions specified in the output data with target labels specified by the training data. The loss function is configurable in a variety of ways, examples of which include regret, Quadratic loss function as part of a least squares technique, and so forth.

Configuration of the training data is usable to support a variety of usage scenarios. In one example, the training data is configured for natural language processing, e.g., to infer intent, locate items, generate prompts, and so forth. A variety of other examples are also contemplated, included the large language models (LLMs) as previously described.

### Example System and Device

FIG. 12 illustrates an example system generally at 1200 that includes an example computing device 1202 that is representative of one or more computing systems and/or devices that implement the various techniques described herein. This is illustrated through inclusion of the digital search service 120. The computing device 1202 is configurable, for example, as a server of a service provider, a device associated with a client (e.g., a client device), an on-chip system, and/or any other suitable computing device or computing system.

The example computing device 1202 as illustrated includes a processing device 1204, one or more computer-readable media 1206, and one or more I/O interface 1208 that are communicatively coupled, one to another. Although not shown, the computing device 1202 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1204 is representative of functionality to perform one or more operations using hardware. Accordingly, the processing device 1204 is illustrated as including hardware element 1210 that is configurable as processors, functional blocks, and so forth. This includes implementation in hardware as an application specific integrated circuit or other logic device formed using one or more semiconductors. The hardware elements 1210 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1206 is illustrated as including memory/storage 1212 that stores instructions that are executable to cause the processing device 1204 to perform operations. The memory/storage 1212 represents memory/storage capacity associated with one or more computer-readable media. The memory/storage 1212 includes volatile media (such as random access memory (RAM)) and/or nonvolatile media (such as read only memory (ROM), Flash memory, optical disks, magnetic disks, and so forth). The memory/storage 1212 includes fixed media (e.g., RAM, ROM, a fixed hard drive, and so on) as well as removable media (e.g., Flash memory, a removable hard drive, an optical disc, and so forth). The computer-readable media 1206 is configurable in a variety of other ways as further described below.

Input/output interface(s) 1208 are representative of functionality to allow a user to enter commands and information to computing device 1202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1202 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1202. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1202, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1210 and computer-readable media 1206 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1210. The computing device 1202 is configured to implement particular instructions and/or functions corresponding to the software and/or hardware modules. Accordingly, implementation of a module that is executable by the computing device 1202 as software is achieved at least partially in hardware, e.g., through use of computer-readable storage media and/or hardware elements 1210 of the processing device 1204. The instructions and/or functions are executable/operable by one or more articles of manufacture (for example, one or more computing devices 1202 and/or processing devices 1204) to implement techniques, modules, and examples described herein.

The techniques described herein are supported by various configurations of the computing device 1202 and are not limited to the specific examples of the techniques described herein. This functionality is also implementable all or in part through use of a distributed system, such as over a “cloud” 1214 via a platform 1216 as described below.

The cloud 1214 includes and/or is representative of a platform 1216 for resources 1218. The platform 1216 abstracts underlying functionality of hardware (e.g., servers) and software resources of the cloud 1214. The resources 1218 include applications and/or data that can be utilized while computer processing is executed on servers that are remote from the computing device 1202. Resources 1218 can also include services provided over the Internet and/or through a subscriber network, such as a cellular or Wi-Fi network.

The platform 1216 abstracts resources and functions to connect the computing device 1202 with other computing devices. The platform 1216 also serves to abstract scaling of resources to provide a corresponding level of scale to encountered demand for the resources 1218 that are implemented via the platform 1216. Accordingly, in an interconnected device embodiment, implementation of functionality described herein is distributable throughout the system 1200. For example, the functionality is implementable in part on the computing device 1202 as well as via the platform 1216 that abstracts the functionality of the cloud 1214.

In implementations, the platform 1216 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a search query;
projecting, by the processing device, a target to achieve a goal of the search query;
generating, by the processing device, one or more search results based on the search query; and
outputting, by the processing device, a progress indicator for display in a user interface, the progress indicator indicating a relative amount of progress towards reaching the target, the amount based on selection of one or more items from the one or more search results.

2. The method as described in claim 1, wherein the target is a number of items to be acquired to achieve the goal and the progress indicator indicates a number of the items selected for acquisition via the user interface.

3. The method as described in claim 1, further comprising identifying the goal based on the search query using an artificial intelligence (AI) search assistant implemented using machine learning.

4. The method as described in claim 1, further comprising generating one or more prompts using an artificial intelligence (AI) search assistant implemented using machine learning based on the search query, the prompts configured to refine the goal.

5. The method as described in claim 4, wherein the one or more prompts include a first said prompt usable to identify a category of a plurality of categories and a second said prompt based on a response to the first said prompt, the second said prompt usable to identify at least one said item within a respective said category.

6. The method as described in claim 1, wherein the projecting is based on a number of categories of items to achieve the goal and the amount is based on selection of the one or more items within the categories.

7. The method as described in claim 1, wherein the generating the one or more search results includes:
detecting a search-query type of the search query using a machine-learning model;
responsive to the detecting the search-query type is a first type, communicating the search query for processing by an algorithmic search engine to generate the search result; and
responsive to the detecting that the search-query type is a second type, communicating the search query for processing using an artificial intelligence (AI) search assistant implemented using a large language model (LLM) to generate the search result.

8. The method as described in claim 7, wherein the first type involves a keyword search and the second type is a natural language search.

9. The method as described in claim 1, wherein the generating the one or more search results includes:
predicting, for the search query, one or more categories of a plurality of categories using machine learning from context data extracted from digital content;
generating a category ranking of the one or more categories based on relevance to the search query;
locating a plurality of said items within the one or more categories;
generating an item ranking of the plurality of said items based on a user profile, a ranking of respective said items within the one or more categories, and the category ranking; and
generating at least one said search result based on the item ranking.

10. One or more computer-readable storage media storing instructions that, responsive to execution by a processing device, causes the processing device to perform operations comprising:
detecting a search-query type of a search query using a machine-learning model;
responsive to the detecting the search-query type is a first type, communicating the search query for processing by an algorithmic search engine to generate a search result;
responsive to the detecting that the search-query type is a second type, communicating the search query for processing using an artificial intelligence (AI) search assistant implemented using a large language model (LLM) to generate the search result; and
outputting the search result.

11. The one or more computer-readable storage media as described in claim 10, wherein the detecting is performed by the machine-learning model trained as a classifier.

12. The one or more computer-readable storage media as described in claim 11, wherein the classifier is implemented using a random-forest machine-learning model or a boosted classifier machine-learning model.

13. The one or more computer-readable storage media as described in claim 10, wherein the first type involves a keyword search and the second type is a natural language search.

14. The one or more computer-readable storage media as described in claim 10, wherein the machine-learning model is trained to classify the search-query type as the second type based on detecting that generation the search result involves inference of intent from the search query.

15. The one or more computer-readable storage media as described in claim 10, wherein the machine-learning model is trained to classify the search-query type as the second type based on detecting that generation the search result involves inference of intent from the search query.

16. The one or more computer-readable storage media as described in claim 10, wherein the algorithmic search engine is configured to generate the search result using Boolean search logic, keyword frequency algorithmic analysis, keyword density algorithmic analysis, hypertext markup language (HTML) tag algorithmic analysis, link algorithmic analysis, lexical algorithmic analysis, static ranking factor algorithmic analysis, pattern matching algorithmic analysis, regular expression algorithmic analysis, semantic algorithmic analysis, or keyword matching algorithmic analysis.

17. The one or more computer-readable storage media as described in claim 10, wherein the algorithmic search engine is configured to generate the search result independent of machine learning.

18. A computing device comprising:
a processing device; and
a computer-readable storage medium storing instructions that, responsive to execution by the processing device, causes the processing device to perform operations including:
predicting, for a search query, one or more categories of a plurality of categories using machine learning from context data extracted from digital content;
generating a category ranking of the one or more categories based on relevance to the search query;
locating a plurality of items within the one or more categories;
generating, by the processing device, an item ranking of the plurality of items based on a user profile, ranking of respective said items within the one or more categories, and the category ranking; and
generating a search result based on the item ranking.

19. The computing device as described in claim 18, wherein the generating the search result includes:
detecting a search-query type of the search query using a machine-learning model;
responsive to the detecting the search-query type is a first type, communicating the search query for processing by an algorithmic search engine to generate the search result; and
responsive to the detecting that the search-query type is a second type, communicating the search query for processing using an artificial intelligence (AI) search assistant implemented using a large language model (LLM) to generate the search result.

20. The computing device as described in claim 18, wherein the generating the search result includes:
detecting a search-query type of the search query using a machine-learning model;
responsive to the detecting the search-query type is a first type, communicating the search query for processing by an algorithmic search engine to generate the search result; and
responsive to the detecting that the search-query type is a second type, communicating the search query for processing using an artificial intelligence (AI) search assistant implemented using a large language model (LLM) to generate the search result.
